(19) United States
(12) Patent Application Publication
(10) Pub. No.: US 2007/0070996 A1
(43) Pub. Date: Mar. 29, 2007

(54) Port hopping scheme for peer-to-peer connections

(76) Inventor: David R. Oran, Acton, MA (US)

Correspondence Address: MARGER JOHNSON & MCCOLLOM, P.C., 210 SW MORRISON STREET, SUITE 400, PORTLAND, OR, 97204, US

(21) Appl. No.: 11/235,870

(22) Filed: Sep. 26, 2005

(51) Int. Cl. H04L 12/56; H04J 3/22; H04L 12/28; H04J 3/16

(52) U.S. Cl. 370/389; 370/465

(57) ABSTRACT

A port hopping scheme pseudo-randomly spreads a peer-to-peer connection across a port space. The pseudo-random port hopping scheme varies port address values in a manner that is unknown to intermediary devices but known by the two endpoints or peers. Flow-identification and control schemes depend on the stability of the flow identification through the 5-tuple that includes source and destination IP addresses, source and destination port addresses, and a protocol type. The peer-to-peer flows that use the port hopping scheme are no longer bound to these identifiers. Thus, an intermediary device cannot build up the necessary state to manipulate the flow. This allows a subscriber to defeat a large class of service provider, or other intermediary, flow policies by rendering the associated flow-identification machinery impotent.

### BACKGROUND

A variety of flow-identification and control schemes exist, including Quality of Service (QoS)-based policing/shaping, Access Control List (ACL)-based discard, and Transmission Control Protocol (TCP)-pacing that manipulates acknowledge (ACK) timing. Many of these control schemes need to identify network traffic at the granularity of a single flow/TCP connection.

Service Providers (SPs) use these, and other schemes, to characterize user traffic through heuristic packet inspection. Some schemes go beyond ACLs, policy download, and path-coupled signaling and control user/subscriber traffic by implementing a SP-specified policy. Such schemes typically operate without the explicit consent of either the source or destination of the traffic.

Some control schemes inspect traffic in a router, switch, or “bump-in-the-wire” appliance in order to identify individual flows of subscriber traffic. Once identified, the flows may be given preferential treatment, for example, by setting a Differentiated Services Code Point (DSCP) for the packets in the flow or by using a higher grade of service. More typically, however, the flows are penalized through wholesale discard, shaping, or policing.

Such schemes are most often employed when the SP under-provisions or over-subscribes their networks. For example, the SP may advertise a certain available bandwidth to customers. However, when subscribers attempt to use the advertised bandwidth for an extended period of time (e.g. for peer-to-peer applications), the SP network facilities become saturated. Rather than rate limiting each subscriber's traffic as a whole, the SP may attempt to rate limit certain high bandwidth peer-to-peer traffic, hoping the users won't notice, or at least won't complain, that the advertised service is not being delivered.

In these situations, the interests of the subscriber and the service provider are not aligned. One solution is to give the user some control over the policy through more flexible bandwidth rate charging and user-initiated policy signaling. For example, the user can control policy either in-band through a path-coupled QoS signaling protocol such as Resource Reservation Setup Protocol (RSVP), or out-of-band through a web-based user-accessible policy server. Unfortunately, few service providers use these approaches and instead throttle user traffic that does not conform to SP operating policy. The present invention addresses this and other problems.

### SUMMARY OF THE INVENTION

A port hopping scheme pseudo-randomly spreads a peer-to-peer connection across a port space. The pseudo-random port hopping scheme varies port address values in a manner that is unknown to intermediary devices but known by the two endpoints or peers. Flow-identification and control schemes depend on the stability of the flow identification through the 5-tuple that includes source and destination IP addresses, source and destination port addresses, and a protocol type. The peer-to-peer flows that use the port hopping scheme are no longer bound to these identifiers. Thus, an intermediary device cannot build up the necessary state to manipulate the flow. This allows a subscriber to defeat a large class of service provider, or other intermediary, flow policies by rendering the associated flow-identification machinery impotent.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a block diagram of a port hopping scheme used in a peer-to-peer connection.

FIG. 2 is a flow diagram showing how the port hopping scheme in FIG. 1 operates.

FIG. 3 is a block diagram showing in more detail how the port hopping scheme uses pseudo-random port addresses to send packets between two peers.

FIG. 4 is a flow diagram showing how the same port hopping scheme can be used for different connections with the same peers.

FIG. 5 is a block diagram showing how encryption can be used to synchronize the port hopping scheme between two peers.

### DETAILED DESCRIPTION

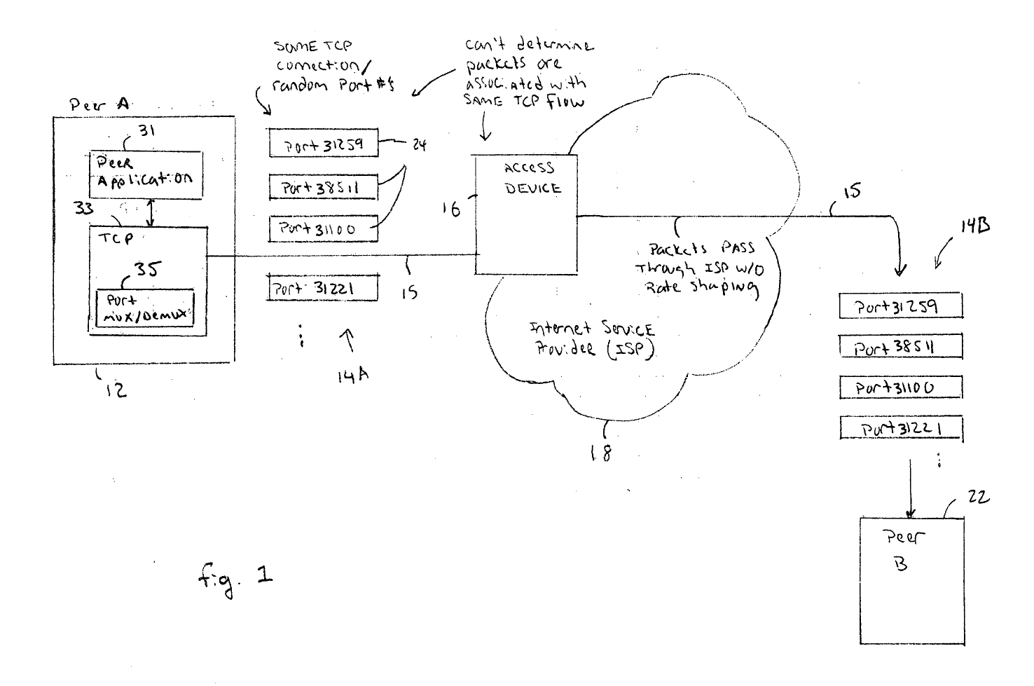

Referring to FIG. 1, peer devices 12 and 22 conduct a synchronized port hopping scheme that uses different variable port numbers 24 to transfer packets 14A during a same Transmission Control Protocol (TCP) connection 15. The peer devices 12 and 22 can be any type of endpoint that establishes a TCP connection 15 with another endpoint. For example, peers 12 and 22 may be computer terminals, Personal Computers (PCs), Personal Digital Assistants (PDAs), smart cellular phones, or any other type of wired or wireless device that initiates or receives Internet communications.

The peer-to-peer connection, flow, session 15, etc. refers to any scheme that maintains a same connection state while transferring packets between two peers. One example of a peer-to-peer connection is a conventional TCP connection that is identified by a TCP/IP 5-tuple that includes source and destination IP addresses, source and destination port addresses, and protocol type. The TCP/IP 5-tuple is used to identify all the packets which form part of the same TCP connection. The port hopping scheme uses the same IP source and destination addresses and same protocol type for the packets in the same TCP connection, but the port numbers “hop around” in a port space on a packet-by-packet basis.

The port-hopping scheme can foil the mid-network flow identification and policy systems used by service providers. For example, the varying port address values 24 prevent an access device 16 operating in an Internet Service Provider (ISP) network 18 from determining that packets 14A are all associated with the same TCP connection 15. As a result, the access device 16 cannot rate limit the packets 14B for a particular TCP connection 15 that pass through ISP network 18. Many times rate limiting is not in the best interest of the user or is against the spirit of the user service contract. Thus, the port hopping scheme can encourage service providers to get the consent and cooperation of users before controlling user traffic.

The peer device 12 operates a peer software application 31 that may need to establish a TCP connection 15. For example, the peer software application 31 may conduct a File Transport Protocol (FTP) operation. The peer software application 31 may call a TCP software module 33 that establishes and maintains the TCP connection 15. The TCP module 33 in this example includes port multiplexing and de-multiplexing software 35 that when executed conducts the port hopping scheme.

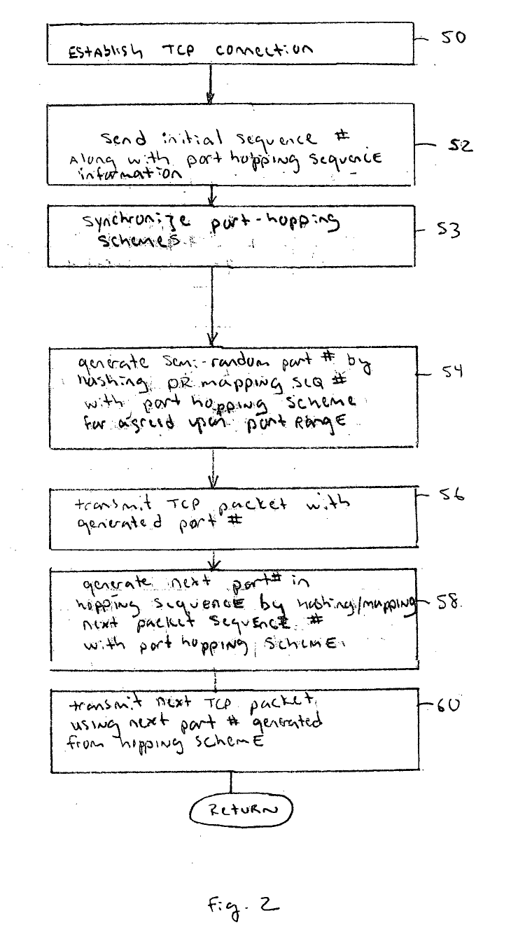

FIG. 2 describes the port hopping scheme in more detail. The port hopping scheme described below may be described in reference generally to peers 12 and 22. However, it should be understood that the port hopping scheme may be conducted by any combination of software and/or hardware that is operated by the peers 12 and 22. For example, as described above with respect to FIG. 1, the port hopping scheme may be performed by port multiplexer/demultiplexer software 35 operated by a TCP software module 33.

In operation 50, the peers 12 and 22 in FIG. 1 establish a TCP connection. This includes one of the peers sending a synchronization (SYN) message and the other peer sending back a SYN acknowledge (SYNACK) message. The initiating peer may send hopping sequence information and an initial sequence number or “seed” used in the port hopping scheme along with other TCP connection parameters in a SYN message in operation 52.

The SYN message could use a random port address. However, a well-known port number may also be used which may be detected by the ISP flow-identification equipment. However, as long as the SYN packet gets through the ISP network 18 (FIG. 1), the initial sequence number can be used to initialize the pseudo-random hopping sequence through the port space for all subsequent packets. The pseudo-random hopping sequence refers to port address values that are varied in a manner that is unknown to intermediary devices but known by the two endpoints or peers.

In operation 53, the peers 12 and 22 (FIG. 1) synchronize port hopping schemes by agreeing on a port-range, the initial sequence number, and a port hopping algorithm or sequence. Ways of identifying the particular port hopping scheme used by the two peers are described in more detail below. After the TCP connection is established, the sending peer in operation 54 starts generating pseudo-random port address values for the packets in the same TCP connection and binding those values to individual sequence numbers in the TCP sequence space. In one example, the sending peer generates the pseudo-random port address values by hashing a TCP sequence number for a next packet into a range equal in size to the port-hopping space for this connection, and then applying the agreed upon port hopping algorithm or sequence within that port range.

In another example, the peers map the sequence space with a port hopping sequence analogous to codes generated in Code Division Multiple Access (CDMA) systems. The larger the available port range, the better the port address spreading and the lower the probability of flow detection. The sending peer then sends the packets on the pseudo-randomly generated ports in operation 56.

The next time a packet is transmitted for the same TCP connection, the sender generates a new pseudo-random port number by hashing or mapping the next sequence number for the next packet using the same port hopping scheme. The peer then sends the next TCP packet in operation 60 using the derived port number. This operation repeats for each subsequent packet that is sent during the same TCP connection.

The peer receiving the TCP packet generates port numbers in the same manner as the sender. The receiving peer reads the sequence number for a received packet and hashes or maps the sequence number for the packet using the previously agreed upon port hopping scheme. If the derived port number matches the port number in the received packet, and the other TCP connection parameters correspond to the same TCP connection, then the packet is identified by the receiver as belonging to the same TCP connection.

It should be understood that any variety of different techniques can be used to derive pseudo-random port address values. For example, a similar algorithm used in wireless frequency hopping systems to derive pseudo-random frequency carrier values can be used to generate the port address values. Alternatively, as described above, the scheme used in wireless CDMA systems for deriving pseudo-random code values can also be used to generate the pseudo-random port address values. In other implementation, a hashing algorithm can be used to generate the pseudo-random code values.

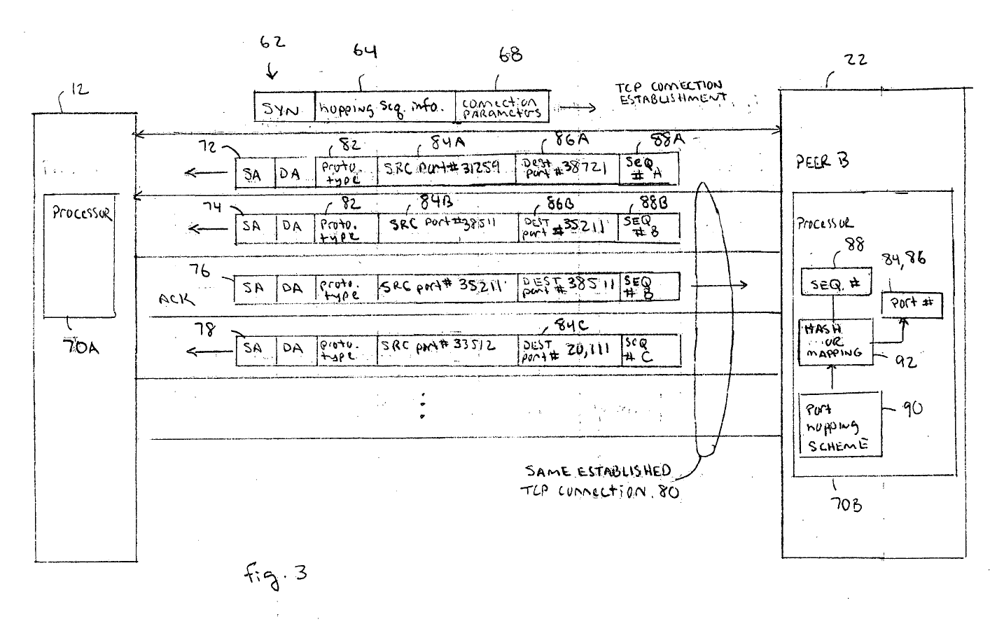

FIG. 3 shows in more detail how the peers A and B conduct the port hopping operations described in FIGS. 1 and 2. In this example, peer 12 (Peer A) initiates a TCP connection by sending a TCP SYN message 62 to a destination IP address associated with peer 22 (Peer B). Peers A and B include processors 70A and 70B, respectively, that perform the port hopping operations described above in FIGS. 1 and 2.

The TCP stacks operating on each peer A and B synchronize their port hopping for each packet transmission so that the receiver can determine on which port to expect each sequenced packet. This port hopping synchronization is conducted by peer A sending a SYN message 62 that includes an initial sequence number 64 or “seed” along with possibly other hopping sequence information 64. The SYN message 62 may also include conventional connection parameters 68 for the TCP connection.

Peer B then synchronizes with the same port hopping state contained in peer B. In this example, after synchronizing port hopping schemes 90, peer B sends a TCP packet 72 to peer A. The TCP packet 72 has a conventional TCP header format that includes a Source Address (SA), Destination Address (DA), and protocol type 82A. The TCP packet 72 includes a TCP sequence number 88A that is used by processor 70B in peer B to generate pseudo-random port numbers 84A and/or 86A.

The random port number may be the source port address value 84A and/or the destination port address value 86B. In this example, both the source port address value 84A and destination port address value 86A are pseudo-randomly generated. However, in other embodiment, only one of the two port address values may be varied.

The processor 70B conducts a hashing or mapping operation 92 using the TCP sequence number 88A and the port hopping scheme or algorithm 90 previously agreed upon by the two peers A and B. The hash or mapping operation 92 produces the source and destination port address values 84A and 86A, respectively, that are used in TCP packet 72.

Other packets 74 and 78 sent by peer B during the same TCP connection 80 use the same IP source address, IP destination address, and protocol type 82. However, in this example, a different source port address value 84 and a different destination port address value 86 within the port-hopping range for the connection are generated for each subsequent packet 74 and 78. For example, the source port number 84B and the destination port number 86B for packet 74 are generated by hashing or mapping the TCP sequence number 88B with the port hopping scheme 90.

The port hopping scheme 90 used for generating the pseudo-random port address values was previously agreed upon between peer A and peer B and synchronized during the establishment of the TCP connection 80. This allows the processor 70A in receiving peer A to use the same hashing or mapping operation 92 previously used by processor 70B to when originally generating the port address values.

For example, peer A receives packet 72 from peer B. Processor 70A reads the sequence number 88A and conducts a similar hash or mapping operation 92 to independently generate the source port address value 84A and destination port address value 86A. Since the port address values generated by processor 70A match the port address values 84A and 86A in packet 72, peer A determines that packet 72 is associated with TCP connection 80. Peer A can similarly send a TCP acknowledge (ACK) message in the reverse direction. In this example, peer 70A sends an ACK message 76 back to peer 70B using the port numbers for the highest sequence number packet the ACK packet 76 is acknowledging. In this example, packet 74 has the highest sequence number 88B and therefore ACK packet 76 uses the port numbers 84B and 86B from received packet 74.

Synchronizing Port Hopping Schemes

As described above, the two TCP software modules in peers A and B in FIG. 3 need to agree upon the same port hopping scheme 90 and then synchronize the port hopping scheme to the same port range or state. The initial port number in hopping sequence information 64 is used as a “seed” for synchronizing to a same port hopping state. The initial port number can be used in the first packet 72. The hopping sequence information 64 also includes a port address range that identifies the range of pseudo-random port address values that can be used for port hopping for this connection.

The peers A and B can use any number of techniques to agree upon a port-hopping scheme. One technique is for the two peers to use an out-of-band agreement. For example, peer A may send peer B an email message that identifies the port hopping scheme 90. Alternatively, peers A and B may each access a same web site to download a same port hopping scheme 90. Any other out of band technique can similarly be used by the two peers to download or identify the port hopping scheme 90 used for the TCP connection 80.

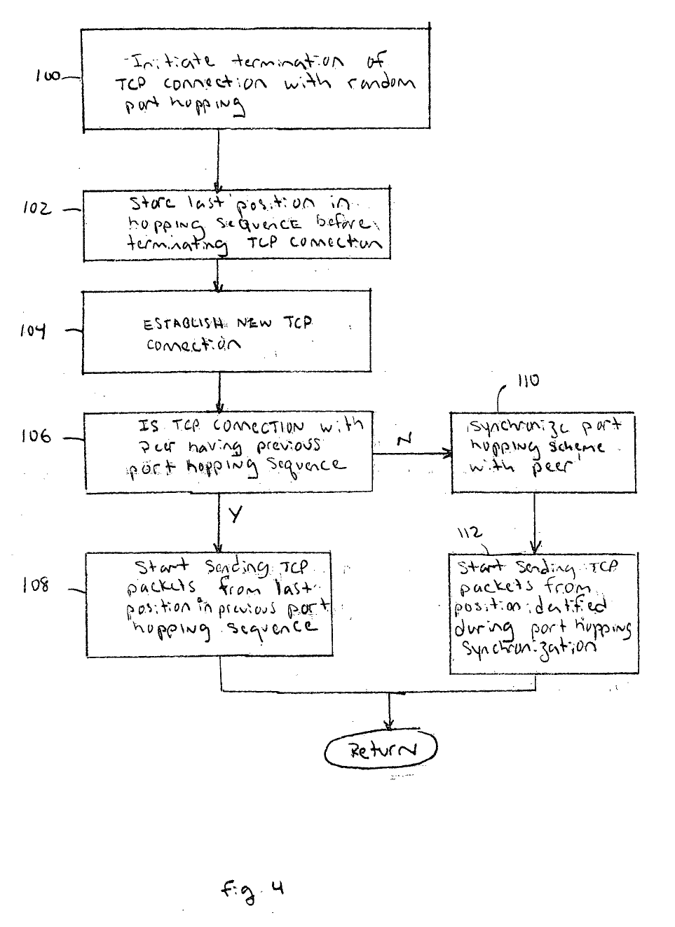

The two peers A and B can also use the state from a previous TCP connection. Referring to FIG. 4, in operation 100 the peers A and B initiate the termination of an established TCP connection in a conventional manner. Before completing the termination of the TCP connection, the two peers A and B in operation 102 store a last state in the port hopping scheme. For example, the peers A and B may store the last sequence number or port address value used for sending a packet in the TCP connection.

Another TCP connection is established between the same two peers in operation 104. The two peers in operation 106 determine if a port hopping scheme was previously conducted. For example, each peer can index the previous port hopping scheme and last stored hopping sequence number with an IP address of the opposite remote peer. If a port hopping scheme was used on a prior connection, then the two peers in operation 108 start generating pseudo-random port addresses starting from the last state in the port hopping scheme from the previous TCP connection.

If the two peers A and B did not use a port hopping scheme in a previous TCP connection, or if some time period has expired since the previously established TCP connection, then a new port hopping synchronization may be required in operation 110. After synchronizing port hopping schemes, the two peers in operation 112 start sending and receiving packets with pseudo-random port address values starting from the agreed upon starting port position.

Optional extension fields may be used in SYN messages to identify the port hopping scheme and starting port number for the two peers. In this example, knowledge of the port hopping sequence or algorithm and initial state are hidden from a flow detector in an intermediary network device using encryption. For example, a Diffie-Hellman exchange can be used for supplying private keys to the two peers A and B. The private keys can then be used to encrypt the port hopping sequence information 64 (FIG. 3) exchanged in the TCP SYN and SYNACK messages.

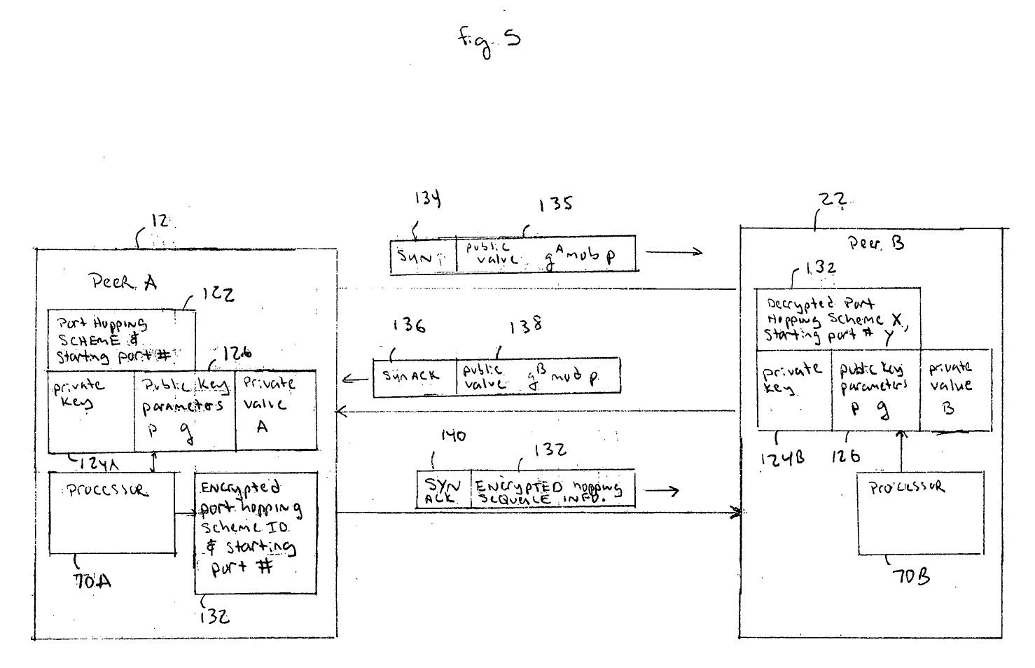

Referring to FIG. 5, peer A stores a port sequence, algorithm, etc. used in the port hopping scheme and a starting port number 122. The peer A also stores a private value A and public key parameters 126. The processor 70A generates a public encryption value 135 using private value A. The public encryption value 135 is sent to peer B in a TCP SYN messages 134. Similarly, processor 70B stores a private value B and public key parameters 126. Processor 70B generates and sends a public encryption value 138 to peer A in a SYNACK message 136. Peers A and B then each independently generate private encryption keys 124A and 124B, respectively, using the public encryption values 135 and 138. The private encryption keys 124A and 124B may be the same or different.

Processor 70A encrypts a port hopping scheme identifier and starting port number 132 using the private encryption key 124 and sends the encrypted port hopping scheme identifier and starting port number 132 to peer B in an ACK message 140. Processor 70B in peer B decrypts the port hopping information 132 using the private encryption key 124B. The two peers A and B then have synchronized their port hopping schemes and start the pseudo-random port hopping.

Hashing

A set of orthogonal perfect hashes can be used for generating the port address values, or a single hash can be used with a set of initial seeds that produce orthogonal hash results. It is possible that different parts of the TCP sequence space will hash to the same port address. This turns out to not be a problem as long as the port range is large enough to ensure that hash collisions on a single flow are much farther apart in the sequence space than the current TCP window. A maximum window size for each connection can be chosen to ensure that the same port number is not used during a same TCP window. In any event, such collisions are not fatal since packets from the same TCP flow can still be distinguished by their sequence number.

More problematical is the possibility of packets from different connections hashing to the same port address value. This can be avoided deterministically through choice of orthogonal hopping sequences. Such sequences are relatively easy to generate through well known techniques like the Walsh codes used for CDMA systems, or the pre-computed hopping sequences used by frequency-hopping radio systems.

Network Address Translators/Port Address Translators (NATs/PATs)

Another complication is the presence of Network Address Translators/Port Address Translators (NATs/PATs) between a peer 12 or 22 and the service provider network 18 (FIG. 1). The port-hopping scheme described above could possibly cause many PAT mappings to be created and not used before the timer in the NAT/PAT removes the state. Therefore, either PAT mappings could get exhausted, or time out. This is relatively easy to deal with by restricting the port hopping scheme to generate the variable port addresses within the same range as the those used by the PAT.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A device, comprising:
a processor establishing a peer-to-peer connection and then using a pseudo-random port hopping scheme to vary port address values used for sending or receiving packets transferred over the same peer-to-peer connection.

2. The device according to claim 1 wherein the peer-to-peer connection is a Transmission Control Protocol (TCP) connection and the processor uses a same source IP address, destination IP address, and protocol type for partially identifying packets in the same TCP connection while using a pseudo-randomly varying port address to further identify the packets in the same TCP connection.

3. The device according to claim 2 wherein the processor sends an initial starting port address value for the port hopping scheme in a TCP synchronization (SYN) message and/or receives the starting port address in a SYN acknowledge (SYNACK) message during TCP connection establishment.

4. The device according to claim 1 wherein the pseudo-random port hopping scheme generates the port address values by hashing or mapping sequence numbers assigned to the packets with the port hopping scheme.

5. The device according to claim 1 wherein the processor uses out of band messages to synchronize a particular port hopping scheme with a remote peer.

6. The device according to claim 1 wherein the processor uses a port hopping scheme from a previously established peer-to-peer connection with a remote peer and starts from a last state from the previously used port hopping scheme for generating the varying port address values in a next peer-to-peer connection with the same remote peer.

7. The device according to claim 1 wherein the processor synchronizes the port hopping scheme with a remote peer during establishment of a TCP connection by sending an encrypted port hopping scheme identifier, together with encrypted values of the port hopping range and initial port state, to the remote peer in a TCP synchronization (SYN) or SYN acknowledge message.

8. The network processing device according to claim 1 wherein the processor restricts the range of port address values that are used in the peer-to-peer connection according to a range of port address values used in an associated Network Address Translator (NAT) or Port Address Translator (PAT).

9. The network processing device according to claim 1 wherein the pseudo-random port hopping scheme used in the peer-to-peer connection prevents an intermediary network device from associating the packets with the same peer-to-peer connection.

10. A method for exchanging information in a network connection, comprising:
establishing a peer-to-peer connection;
generating or receiving packets for the peer-to-peer connection; and
using a port hopping scheme to vary port addresses or identify varying port addresses, for the packets in the same peer-to-peer connection.

11. The method according to claim 10 including using a same Internet Protocol (IP) source address and a same IP destination address for the packets in the same peer-to-peer connection while using a pseudo-randomly varying source port address and/or destination port address for the packets in the same peer-to-peer connection.

12. The method according to claim 10 including varying Transmission Control Protocol (TCP) port address values for packets in a same TCP connection and using the varying TCP port address values to prevent an intermediary network device from determining that the packets are from the same TCP connection.

13. The method according to claim 10 including synchronizing the port hopping scheme with an opposite peer in the peer-to-peer connection so that the varying port addresses are independently generated both locally and at the opposite peer.

14. The method according to claim 10 including:
establishing a first peer-to-peer connection with a remote peer;
using a port hopping scheme synchronized with the remote peer to generate the varying port addresses;
identifying a port hopping scheme state when the first peer-to-peer connection is terminated;
establishing a second peer-to-peer connection with the same remote peer; and
using the same packet hopping scheme used during the first peer-to-peer connection starting from the previously identified state for generating the varying port addresses for the second peer-to-peer connection.

15. The method according to claim 10 including:
identifying sequence numbers assigned to the packets;
generating the varying port addresses by hashing or mapping the sequence numbers with a port hopping sequence or algorithm; and
using the varying port addresses with the packets associated with the same sequence numbers.

16. The method according to claim 10 including sending an initial port number for the port hopping scheme in a Transmission Control Protocol (TCP) synchronization (SYN) or SYN acknowledge message while establishing a TCP connection.

17. The method according to claim 10 including:
conducting an encryption key information exchange while establishing a TCP connection with a remote peer;
using an encryption key generated after the encryption key information exchange to encrypt a port hopping scheme identifier; and
sending the encrypted port hopping scheme identifier to the remote peer while establishing the TCP connection.

18. The method according to claim 10 including restricting a range of variable port addresses used in the peer-to-peer connection according to a range of port address values used in an associated Network Address Translator (NAT) or Port Address Translator (PAT).

19. A computer readable medium containing instructions that when executed perform as follows:
establishing a peer-to-peer connection with a remote peer;
generating or receiving packets for the peer-to-peer connection; and
using a port hopping scheme to vary port addresses or identifying varying port addresses, for the packets in the same peer-to-peer connection.

20. A system for exchanging information in a network connection, comprising:
means for establishing a peer-to-peer connection;
means for generating or receiving packets for the peer-to-peer connection; and
means for using a port hopping scheme to vary or identify varying port addresses for the packets in the same peer-to-peer connection.

21. The system according to claim 20 including means for using a same Internet Protocol (IP) source address and a same IP destination address for the packets in the same peer-to-peer connection while using a pseudo-randomly varying source port address and/or destination port address for the packets in the same peer-to-peer connection.

22. The system according to claim 20 including means for varying Transmission Control Protocol (TCP) port address values for packets in a same TCP connection and using the varying TCP port address values to prevent an intermediary network device from determining that the packets are from the same TCP connection.

23. The system according to claim 20 including means for synchronizing the port hopping scheme with an opposite peer in the peer-to-peer connection so that the varying port addresses are independently generated both locally and at the opposite peer.
